(19) United States
(12) Patent Application Publication
(10) Pub. No.: US 2011/0302593 A1
(43) Pub. Date: Dec. 8, 2011

(54) Processing An Asynchronous Message Event

(76) Inventors: Chad Gatesman, Southbury, CT (US); Benny Tseng, Brookfield, CT (US); Dirk Flachbart, Brookfield, CT (US)

(21) Appl. No.: 12/796,168

(22) Filed: Jun. 8, 2010

(51) Int. Cl. G06F 9/46

(52) U.S. Cl. 719/313; 719/318

(57) ABSTRACT

A technique includes capturing an event associated with communication of an asynchronous message due to execution of an application instance. The technique includes processing the message event on a processor-based machine, which includes selectively routing data indicative of the event to an analyzer to determine a latency of the communication based on an affiliation of the message.

### BACKGROUND

The invention generally relates to processing an asynchronous message event.

In today's complex information technology (IT) environment, business transactions typically include a number of steps, which may involve the communication of a mixture of synchronous and asynchronous messages. In synchronous messaging, an application instance waits for a response to a message that is placed in a messaging queue before continuing execution; and in asynchronous messaging, the application continues execution without waiting for the response. Asynchronous messaging may employ such messaging services as the Java® Messaging Service (JMS) or Microsoft® Message Queue (MSMQ).

The latency of the asynchronous messaging may be used as a performance metric to quantize the performance of business transactions. Besides being used to directly assess the underlying messaging transport efficiency, the metric also provides valuable insight into back end service availability and the overall processing pace.

### BRIEF DESCRIPTION OF THE DRAWING

FIG. 1 is a block diagram of a system of physical machines according to implementations.

FIG. 2 is a flow diagram depicting a technique to process an asynchronous message event according to implementations.

FIG. 3 is a flow diagram depicting a technique to capture events associated with the communication of asynchronous messages according to implementations.

FIGS. 4 and 5 are flow diagrams depicting techniques performed by a latency analyzer to process message events according to implementations.

FIG. 6 is a schematic diagram of a system to illustrate ways to process asynchronous message events according to different implementations.

### DETAILED DESCRIPTION

Systems and techniques are described herein for purposes of capturing asynchronous message events, distributing the processing of these events to latency analyzers and using the analyzers to correlate the events so that asynchronous messaging latencies may be accurately and efficiently determined. As their names imply, the latency analyzers also determine the times between correlated send and receive events for purposes of determining the associated latencies of the corresponding asynchronous message communications. As described herein, there may be multiple latency analyzers, and each analyzer may be associated with determining the asynchronous messaging latencies that are associated with one or multiple business transaction types and/or business classifications.

As described below, send and receive events that are part of each asynchronous message communication may originate from different execution environments, such as application instances on different hosts, for example. Furthermore, the latency analyzers may reside on the same or on in different execution environments as well. Regardless of the actual execution environments for the application instances and analyzers, the systems and techniques that are disclosed herein includes agents that use filters to recognize and capture send and receive message events; generate corresponding capture events that describe the message events; and selectively route these captured events to the latency analyzers based on affiliations (such as business transaction type or classification, for example) of the underlying messages.

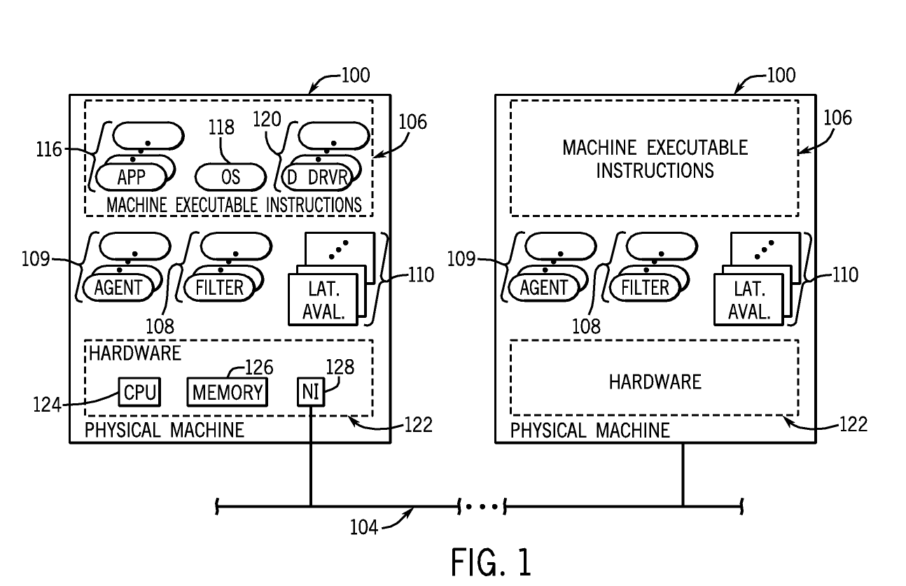

As a more specific example, in accordance with some embodiments of the invention, a system depicted in FIG. 1 includes multiple physical machines 100 that are interconnected by a network 104. Examples of physical machines include computers (e.g., application servers, storage servers, web servers, etc.), communications modules (e.g., switches, routers, etc.) and other types of machines. The network 104 may also include system buses or other fast interconnects. “Physical machine” indicates that the machine is an actual machine made up of executable program instructions and hardware.

Examples of the network 104 include a local area network (LAN), a wide area network (WAN), the Internet, or any other type of communications link. The physical machines may be located within one cabinet (or rack); or alternatively, the physical machines may be located in multiple cabinets (or racks).

The system that is depicted in FIG. 1 may be any one of an application server, a storage server farm (or storage area network), a web server farm, a switch or router farm, other type of data center, and so forth. Also, although two physical machines 100 are depicted in FIG. 1, it is noted that more than two physical machines 100 or one physical machine 100 may be used in accordance with other implementations.

Although each of the physical machines 100 is depicted in FIG. 1 as being contained within a box, it is noted that a physical machine 100 may be a distributed machine having multiple nodes, which provide a distributed and parallel processing system.

As depicted in FIG. 1, in some implementations the physical machine 100 may store machine executable instructions 106. These instructions 106 may include one or multiple applications 116, an operating system 118 and one or multiple device drivers 120 (which may be part of the operating system 118).

The physical machine 100 may also include hardware 122, which includes a processor, such as one or multiple central processing unit (CPUs) 124 (one CPU 124 being depicted in FIG. 1 for purposes of a non-limiting example). Each CPU 124 may have one or multiple processing cores. The hardware 122 may also include a system memory 126 and a network interface 128. In some implementations, one or multiple CPUs 124 execute the machine executable instructions 106.

In general, each physical machine 100 may also include one or multiple sets of machine executable instructions, called “agents 109,” which are responsible for monitoring asynchronous message events that are generated by application instances. In some implementations, each agent 109 executes in the process space of a particular application 116 being monitored, and one or multiple CPUs 124 may execute the underlying machine executable instructions. The agent 109 intercepts certain asynchronous messaging events that are generated by instances of the application 116, such as a send event (when an asynchronous message is sent by an application instance) and a receive event (when an asynchronous message is received by an application instance), as non-limiting examples. The agent 109 captures the current application processing state for each captured event and generates data indicative of the captured event.

The agent 109 routes data indicative of the captured event to a particular latency analyzer 110, in accordance with some implementations. The latency analyzer 110 may be formed by machine executable instructions that are executed by one or multiple CPUs 124 in some implementations. It is noted that the latency analyzer 110 may or may not be disposed on the same physical machine 100 as the agent 109. The agent 109 selectively routes the captured event data to a particular analyzer 110 based on an affiliation of the underlying message.

As a more specific example, in some implementations, the latency analyzer 110 routes the captured event data to a particular analyzer 110 based on an affiliation of the underlying message, such as a particular business transaction type or business classification. In this manner, a given latency analyzer 110 may be designated to process latencies associated with one or multiple business transaction types or business classifications. For these implementations, the agents 109 route captured event data to the latency analyzer 110 based on the business transaction(s)/classification(s) so that certain analyzers 110 receive the event data for certain message affiliations.

Depending on the particular implementation, the agents 109 may be disposed on the physical machine 100 on which the latency analyzer 110 resides as well as be disposed on other physical machines 100. In some implementations, each latency analyzer 110 processes the received capture event data, correlates the captured events to specific asynchronous messages (using correlation tokens in the messages, for example) and determines the corresponding latencies. In this manner, the latency analyzer 110 may determine the time difference between correlated send and receive events and apply corresponding arithmetic aggregation operations (maximum, minimum and averaging operations, as non-limiting examples) over a given reporting period (a five minute interval, as a non-limiting example). The latency analyzer 110 is constructed to both produce aggregated monitoring and instance tracing data, in accordance with some implementations.

The capturing of message events by the agent 109 is aided by a data collection filter 108. In this regard, the filter 108 is a “smart filter” that establishes matching conditions that are satisfied by an application 116 (through an associated agent 109) to cause the triggering of a capture event. For example, a given set of matching conditions may cause the capture of a message event that is affiliated with a specific type of business transaction or classification. The data collection filter 108 also defines what data attributes go into the capture event, such as data that is indicative of the application state.

In some implementations, the agent 109 directs data indicative of the capture event to a particular destination. In some implementations this means that the agent 109 routes, or directs, the capture event data to a particular latency analyzer 110 (for determining the latency of the associated message communication) and a data repository 117 (for storing the capture event data) based on an affiliation of the underlying message. A particular set of matching conditions is associated with a given message affiliation and is associated with a particular destination for the associated capture event data; and in general, the filter 108 controls when and what to send, while the affiliation (such as the associated business classification/transaction) is determinative of where to send this data.

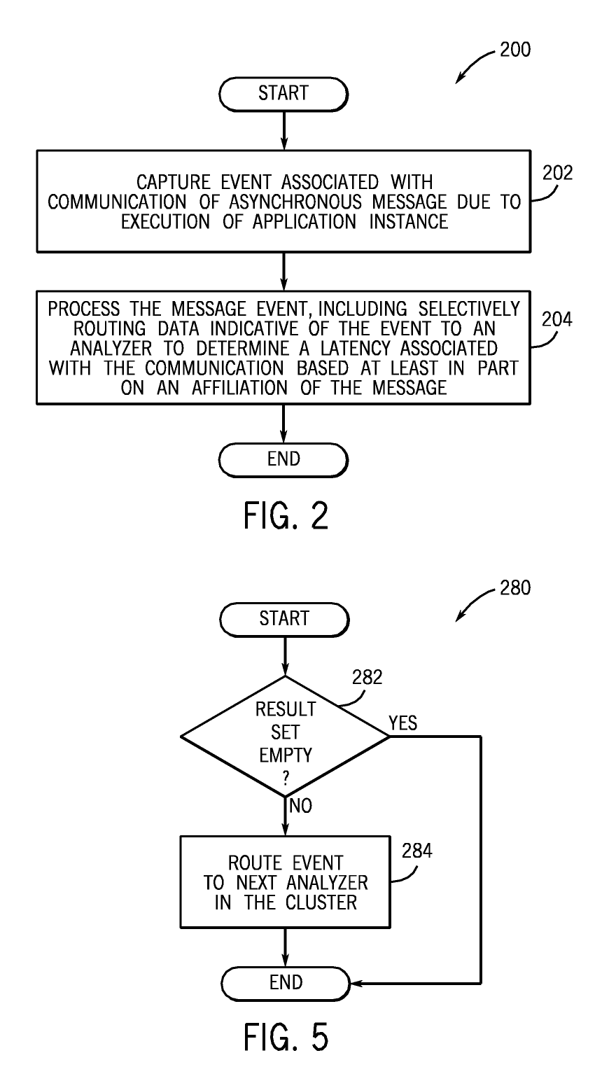

Referring to FIG. 2 in conjunction with FIG. 1, thus, in accordance with some embodiments of the invention, a technique 200 includes capturing (block 202) a message event associated with communication an asynchronous message due to execution of an application instance. The technique 200 includes processing the message event, including selectively routing data indicative of the captured event to a latency analyzer 110 to determine the latency based at least in part on an affiliation (business transaction type or classification, for example) of the message event, as depicted in block 204.

In accordance with some implementations, the matching conditions that are applied by the filter 108 may be solely based on meta data filtering. In this regard, the filter 108 may filter to determine the affiliation of the underlying message based on the meta data of the asynchronous message event, such as a host name, program name, application programming interface (API) name, queue name, etc. In other implementations, the filter 108 may perform event matching based on payload data of the message event. In this regard, actual payload data may be more directly associated with defining a business transaction type or classification. Thus, in other implementations, the matching may be based on payload data. However, many variations are contemplated, and as such, in accordance with other implementations, the filter 108 may perform event matching based on a combination of meta data and payload data.

The filters 108 allows the agents 109 to make smarter and fine-grained decisions based on both the information technology (IT) and the business context. This extension is particularly useful in managing modern day hub-and-spoke and enterprise bus (ESP) architectures, where different types of traffic funnel through a central broker (or hub) or broker cluster. The brokers make routing decisions by executing rules against message data. The filters 108 work in line with such mechanisms.

A user may define complex filtering matching conditions to identify certain affiliations based on meta data and/or business payload data; and the filter 108 may exist in one of many different forms. As an example, the filter 108 may use a regular expression or XPath-based matching pattern. This provides a data driven way for the user to configure routing through pattern matching. In another implementation, the filter 108 may be implemented using machine executable instructions called scripting language. In this regard, users may implement more complicated matching logic through scripting language, and a scripting-based solution allows dynamic and iterative configuration through an administration user interface. The scripts may be delivered to the agents 109 through existing configuration transport without additional installation, in accordance with some implementations. As yet another example, the filter 108 may be implemented through other machine executable instructions other than scripting language for more complicated matching logic cases.

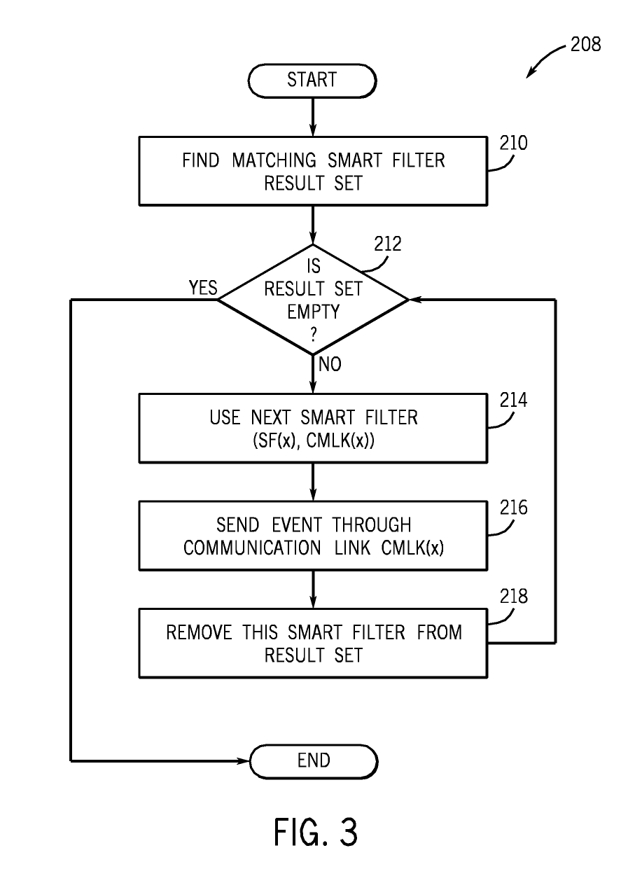

Referring to FIG. 3 in conjunction with FIG. 1, in accordance with some implementations, a given agent 109 may perform a technique 208 that depicted in FIG. 3 for purposes of recognizing and processing captured asynchronous message events. Referring to FIG. 3, pursuant to the technique 208, the agent 109 first finds (block 210) a matching filter result set. Each entry (called “SF(x)” below) of the set is indexed by entry number “x” and contains data indicative of the captured event; and each SF(x) entry is associated with a destination value (called “CMLK(x)”), which identifies the destination (latency analyzer and data depository) for processing the captured event. The CMLK(x) value is determined based on an affiliation of the captured event.

Pursuant to the technique 208, the agent 109 determines (diamond 212) whether the matching filter result set is empty. If so, then the technique 208 terminates. Otherwise, the agent 109 determines the filter duple result (SF(x), CMLK(x)), pursuant to block 214, and then the agent 109 communicates data indicative of the captured event to the final destination as specified by CMLK(x) value, pursuant to block 216. The agent 109 then removes the entry from the result set, pursuant to block 218, and control returns to diamond 212.

While the filters 108 improve routing decision accuracy, the filtering may not cover all cases. To accommodate any discrepancy, event re-routing may be used. More specifically, in accordance with some implementations, the latency analyzers 110 may be organized in a cluster that is distributed over multiple hosts and physical machines 100 (see FIG. 1, for example). Simply put, a particular latency analyzer 110 may decide to re-send an event to another analyzer 110, once the originating analyzer 110 concludes that the event does not belong to the original analyzer 110.

In general, analyzer re-routing may occur in at least two different use cases. The first case involves re-routing based on the results obtained by a filter 108, for the special case where the analyzer 110 performs the processing for the filter 108. In this manner, the filter 108 may be better suited to be executed in the latency analyzer 110 rather than in the agent context. This may be attributable to the complexity of filtering logic or consideration to the performance impact to the monitored applications 116.

In the other use scenario, the re-routing may be based on a time condition. In this regard, this takes care of the case when imperfect agent/analyzer routing results in matching events that are processed by different latency analyzers 110. In the aggregated monitoring use case, metric aggregation is triggered on a regular basis (such as every five minutes, as a non-limiting example). Executing at a compatible frequency, each latency analyzer 110 periodically monitors the messaging events to identify events that have not been correlated in a five minute window (as a non-limiting example) and subsequently re-routes those events to the other analyzers 110 in the cluster in a round robin fashion. Any unmatched events at the end of the routing exercise are considered as orphan events that do not contribute to the latency calculation.

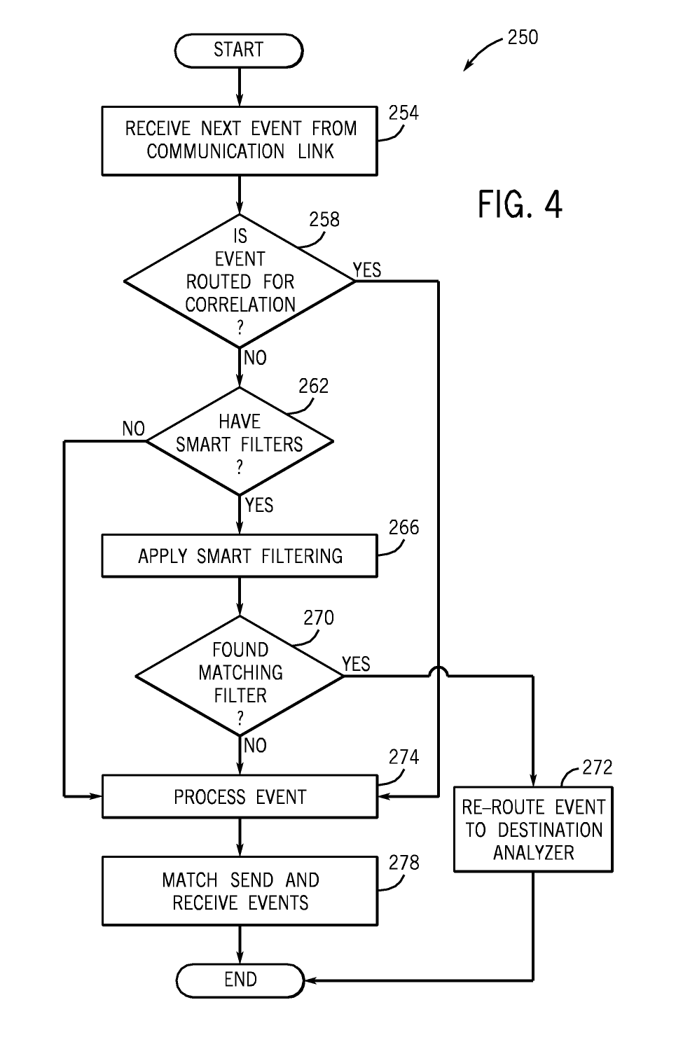

In accordance with some implementations, the latency analyzer 110 performs a technique 250 that is depicted in FIG. 4. Pursuant to the technique 250, the latency analyzer 110 receives the next capture event, pursuant to block 254. If the analyzer 110 determines (diamond 258) that the event is routed to the analyzer 110 for correlation by the analyzer, then the latency analyzer 110 processes the event, pursuant to block 274. Otherwise, if the event is not routed for correlation, the analyzer 110 goes ahead and processes the event, pursuant to block 274 if the analyzer determines (diamond 262) that the analyzer 110 does not have a filter 108. Otherwise, if the analyzer 110 has a filter 108, then the analyzer 110 applies the filter or filters, pursuant to block 266. If the analyzer 110 then determines, pursuant to diamond 270, that a matching filter result has been found, then the analyzer 110 reroutes the event to the appropriate destination analyzer 110, pursuant to block 272. Otherwise, if the matching filter result is not found, the analyzer 110 processes the event, pursuant to block 274 and subsequently matches send and receive events in a latency calculation, pursuant to block 278.

FIG. 5 depicts a technique 280 that may be performed by the latency analyzer 110 for purposes of finding uncorrelated asynchronous message capture events, which exceed some aging threshold. Pursuant to the technique 280, the latency analyzer 110 determines (diamond 282) whether the filter result set is empty, and if so, the technique 280 is terminated. Otherwise, if one or more uncorrelated events exceed the aging threshold, then the latency analyzer 110 routes (block 284) the event to the next analyzer 110 in the cluster.

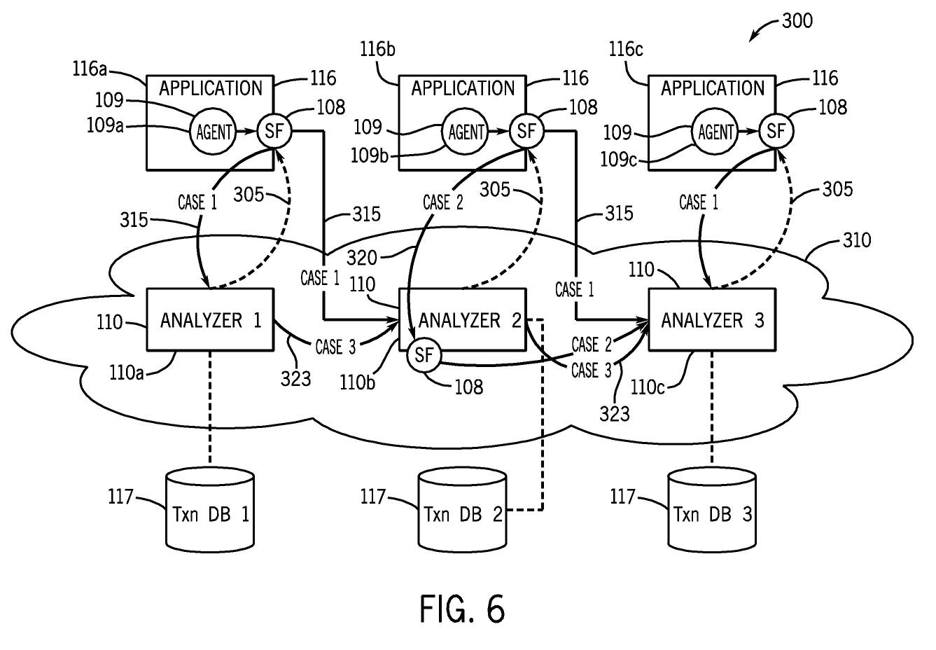

Referring to FIG. 6, an exemplary system 300 illustrates the use of the latency measurement systems and techniques that are disclosed herein. For the example depicted in FIG. 6, the system 300 includes three application instances 116a, 116b and 116c; and within these application instances are executing agents 109a, 109b and 109c, respectively. Each of the agents 109a, 109b and 109c are associated with a respective filter 108. The application instances 116a, 116b and 116c execute, for this example, on different hosts and interact with latency analyzers 110a, 110b and 110c, respectively, which may or may not be located on the respective host of the application 116. For this example, the latency analyzers 110a, 110b and 110c are located in a cluster 310 of analyzers 110 that may be connected together by a network or the like. As also shown in FIG. 6, the analyzers 110 have access to data repositories 117.

The agents 109, application instances 116, filters 108 and latency analyzers 110 may be used according to three exemplary scenarios that are depicted in FIG. 6.

For the illustrated first scenario, the filters 108 may be configured by human users and deployed by analyzers 110 to respective agents 109 through communication links 305. For this scenario, the agents 109 intercept application asynchronous message by applying the filters 108 and generate data indicative of the captured event by applying the filters 108. The captured event data is selectively communicated along corresponding paths 315 to latency analyzers 110 based on message affiliations to perform the latency processing.

For the second scenario, an agent 109b communicates data indicative of a message event over a communication path 320 to the latency analyzer 110b. The latency analyzer 110b executes a smart filter 108 for purposes of identifying captured events; and if a match occurs, the latency analyzer 110b routes the captured event to its final destination for this example along communication path 330 to latency analyzer 110c.

For the third scenario, the analyzers 110a, 110b and 110c look for unmatched events and re-route data indicative of the events to other analyzers 110 in the cluster for matching in a round robin fashion along communication paths 323.

While the present invention has been described with respect to a limited number of embodiments, those skilled in the art, having the benefit of this disclosure, will appreciate numerous modifications and variations therefrom. It is intended that the appended claims cover all such modifications and variations as fall within the true spirit and scope of this present invention.

What is claimed is:

1. A method comprising:
capturing a message event associated with communication of an asynchronous message due to execution of an application instance; and
processing the message event on a processor-based machine, comprising selectively routing data indicative of the event to an analyzer to determine a latency associated with the communication based at least in part on an affiliation of the message.

2. The method of claim 1, wherein the affiliation comprises a business transaction affiliation or a business classification affiliation.

3. The method of claim 1, wherein the act of capturing the message event comprises capturing an event associated with sending the message or capturing an event associated with the receiving of the message.

4. The method of claim 1, wherein the act of capturing the message event comprises:
filtering events due to execution of the application instance.

5. The method of claim 4, wherein the act of filtering the events comprises:
filtering message events based at least in part on meta data associated with the asynchronous message.

6. The method of claim 5, wherein the act of filtering the message events based at least in part on the meta data comprises:
filtering the message events based on a host, program name, queue name and application programming interface name associated with the asynchronous message.

7. The method of claim 4, wherein the act of filtering the message events comprises:
filtering the message events based at least in part on payload data associated with asynchronous messages.

8. The method of claim 1, further comprising:
communicating other data indicative of another event to the analyzer, said another event being associated with communication of the asynchronous message due to execution of another application instance; and
processing the data indicative of the event and said other data indicative of said another event in the analyzer to determine the latency.

9. The method of claim 1, wherein the act of capturing comprises:
capturing the event in an analyzer associated with determining message latencies.

10. The method of claim 1, wherein the act of processing the message event comprises:
communicating the data from another analyzer associated with determining message latencies to the first analyzer to determine the latency.

11. The method of claim 10, wherein the act of communicating the data from said another analyzer occurs in response to the event not being associated with an asynchronous message within a period of time.

12. The method of claim 10, wherein the act of communicating the data from said another analyzer occurs in response to the act of capturing being performed by a filter of the first analyzer.

13. An article comprising a computer readable storage medium to store instructions that when executed by a computer cause the computer to:
filter message events associated with asynchronous messages to determine affiliations associated with the messages;
generate capture events indicative of the message events and the associated affiliations; and
based on the affiliations, selectively route the capture events to analyzers to determine latencies of the asynchronous messages.

14. The article of claim 13, wherein the affiliations comprises business transaction affiliations or business classification affiliations.

15. The article of claim 13, wherein the filtered events comprise message send events and message receive events.

16. The article of claim 13, the storage medium storing instructions that when executed by the computer cause the computer to filter the events based on meta data associated with the asynchronous messages.

17. The article of claim 13, the storage medium storing instructions that when executed by the computer cause the computer to filter the events based on payload data associated with asynchronous messages.

18. A system comprising:
a processor-based filter to capture an event associated with communication of an asynchronous message due to execution of an application instance; and
a processor-based agent to selectively route data indicative of the event to an analyzer to determine a latency of the asynchronous message based at least in part on an affiliation of the message.

19. The system of claim 18, wherein the filter is part of an analyzer to determine asynchronous messaging latencies.

20. The system of claim 18, wherein the filter is adapted to recognize events associated with sending the asynchronous message and receiving the asynchronous message.
